(19) United States
(12) Patent Application Publication
(10) Pub. No.: US 2004/0202922 A1
(43) Pub. Date: Oct. 14, 2004

(54) Mobile phone and battery-fixing device

(75) Inventors: Teng-Yi Tsai, Taipei (TW); Hsueh-Wen Sun, Taipei (TW)

Correspondence Address: QUINTERO LAW OFFICE, 1617 BROADWAY, 3RD FLOOR, SANTA MONICA, CA, 90404, US

(73) Assignee: BENQ Corporation

(21) Appl. No.: 10/822,535

(22) Filed: Apr. 12, 2004

(30) Foreign Application Priority Data
Apr. 14, 2003 (TW) 92205785

(51) Int. Cl. H01M 2/10; H04B 1/38

(52) U.S. Cl. 429/96; 429/97; 455/572; 429/100

(57) ABSTRACT

A mobile phone and a battery-fixing device. The mobile phone includes a body, an engaging member, and a battery. The engaging member is moveably disposed on the body, and includes a rib having an inclined surface. The battery is detachably disposed on the body, and includes a concave portion corresponding to the rib. The rib is located in the concave portion, and can be separated from the concave portion by the inclined surface. Thus, the battery can be separated from the body.

### BACKGROUND OF THE INVENTION

1. Field of the Invention

The invention relates to a mobile phone and a device for fixing a battery therein; in particular, the invention relates to a mobile phone with an easily removable battery.

2. Description of the Related Art

In conventional mobile phones, batteries are fixed within the chassis or structure of the phone, normally within the housing of a phone, or beneath a dedicated cover. Additionally, to remove the battery, some form of release mechanism is normally employed. Disposition of this mechanism is an important design consideration, and can often compromise appearance and efficient function of the phone.

Specifically, the battery can be removed by an elastic member, such as a connector. When a knob is pushed, the battery is slightly lifted, allowing the battery to be removed.

FIGS. 1a-2b illustrate a conventional mobile phone 1 including a body 10 and a battery 20. Referring to FIG. 1a, the body 10 includes a receiving portion 11 therein, and a protrusion 12 is formed around the receiving portion 11. A connector 13 is disposed in the receiving portion 11. Referring to FIG. 1b and FIG. 2a, the battery 20 includes a concave portion 21, corresponding to the protrusion 12 of the body 10, at its side wall. A moving portion 22 is disposed on a surface, facing the surrounding, of the battery 20.

To separate the battery 20 from the body 10, the removing portion 22 of the battery 20 is pushed so that the protrusion 12 of the body 10 is disengaged from the concave portion 21 of the battery 20. Then, the battery 20 is lifted by the connector 13 so as to be removed.

It is noted that the moving portion 22 is not illustrated in detail in FIG. 2b.

The disadvantage of the conventional mobile phone is that the size of the battery and the receiving portion on the body must be precisely controlled. Specifically, to maintain integrity of the appearance and prevent the battery from vibrating, the gap between the battery and the receiving portion must be very small. When the battery is too big or the receiving portion is too small, the battery cannot be normally ejected due to the friction between the battery and the receiving portion, making removal of the battery inconvenient. Additionally, it is difficult to manufacture a mobile phone with an accurate-sized battery and receiving portion.

### SUMMARY OF THE INVENTION

In view of this, the invention provides a mobile phone with an easily removable battery.

Accordingly, the invention provides a mobile phone including a body, an engaging member, and a battery. The engaging member is moveably disposed on the body, and includes a first rib having a first inclined surface. The battery is detachably disposed on the body, and includes a first concave portion corresponding to the first rib. The first rib is located in the first concave portion, and the battery is lifted by the first inclined surface so as to be separated from the body.

In a preferred embodiment, the engaging member includes a second rib, and the battery includes a second concave portion corresponding to the second rib. The second rib is located in the second concave portion. The engaging member includes a first surface and a second surface. A normal vector of the first surface is perpendicular to a moving direction of the engaging member. The first rib is formed on the first surface. A normal vector of the second surface is parallel with the moving direction of the engaging member. The second rib is formed on the second surface. The second rib includes a second inclined surface. A first angle is formed between the first inclined surface and the normal vector of the second surface. A second angle is formed between the second inclined surface and the normal vector of the second surface. The first angle is smaller than the second angle. The engaging member includes a third surface, and a normal vector of the third surface is perpendicular to the moving direction of the engaging member. The second surface connects the first surface and the third surface. The first surface and the second surface are covered by the battery, and the third surface is exposed by the body.

In another preferred embodiment, the body includes a slot, and the battery includes a protrusion corresponding to the slot. The protrusion and the second concave portion are formed on opposite sides of the battery.

In this invention, a device for fixing a battery of a mobile phone is provided. The mobile phone includes a body and a battery, and the battery includes a concave portion. The device includes a main part and a rib. The main part is moveably disposed on the body. The rib is integrally formed on the main part, and includes a first inclined surface. The first rib is located in the concave portion, and the battery is lifted by the first inclined surface so as to be separated from the body.

### BRIEF DESCRIPTION OF THE DRAWINGS

The present invention can be more fully understood by reading the subsequent detailed description and examples with references made to the accompanying drawings, wherein:

FIG. 1a is a perspective view of a body of a conventional mobile phone;

FIG. 1b is a perspective view of a battery of the conventional mobile phone;

FIG. 2a is a rear view of the conventional mobile phone;

FIG. 2b is a cross section along a line V1-V1 in FIG. 2a;

FIG. 3a is a perspective view of a body of a mobile phone as disclosed in the invention;

FIG. 3b is an enlarged view of a portion A in FIG. 3a;

FIG. 4a is a perspective view of a battery of a mobile phone as disclosed in the invention;

FIG. 4b is an enlarged view of a portion B in FIG. 4a;

FIG. 5a is a rear view of a body of the mobile phone in FIG. 3a, wherein the battery is combined with the body;

FIG. 5b is a cross section along a line V2-V2 in FIG. 5a;

FIG. 5c is an enlarged view of a portion C in FIG. 5b;

FIG. 6a is another cross section in FIG. 5a, wherein the battery is separated from the body; and

FIG. 6b is an enlarged view of a portion D in FIG. 6a.

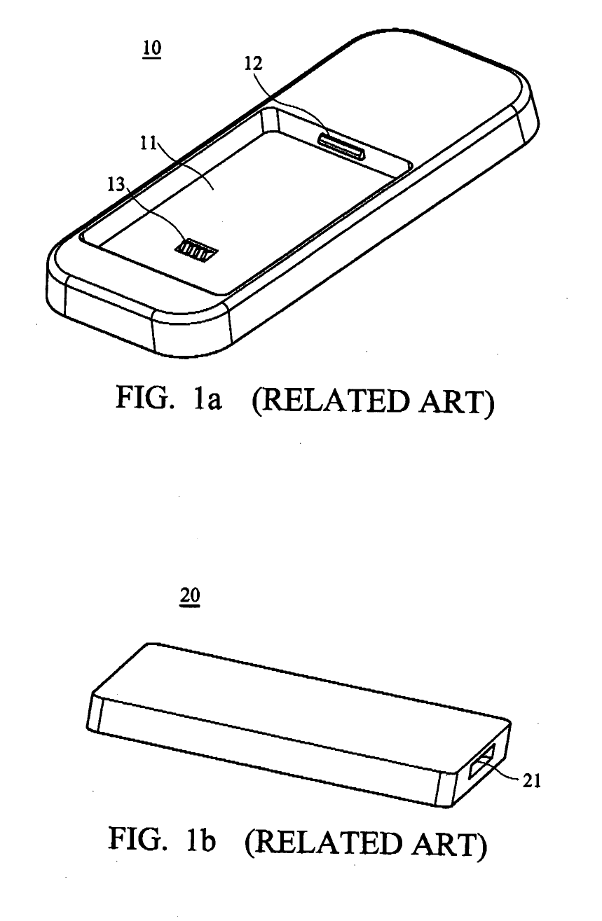

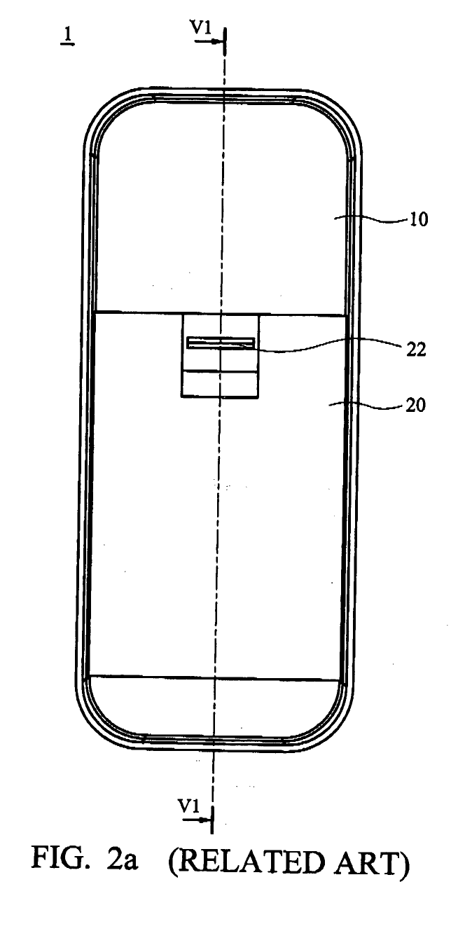

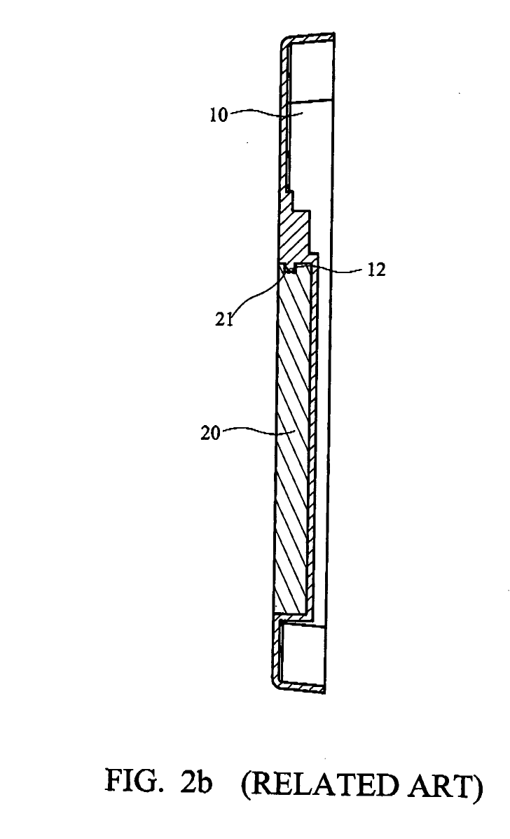

### DETAILED DESCRIPTION OF THE INVENTION

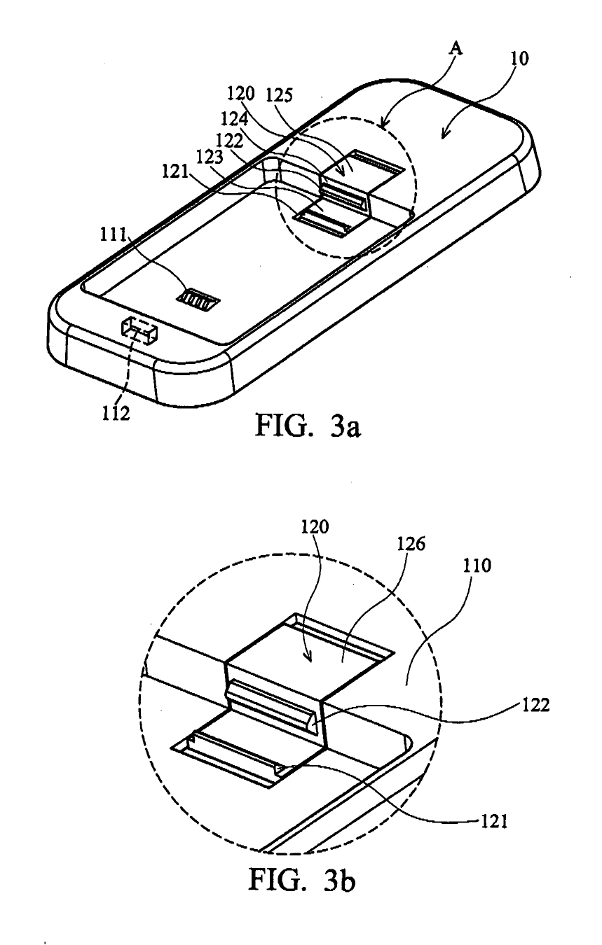

FIGS. 3a-6b are schematic views of a mobile phone 100 as disclosed in the invention. The mobile phone 100 includes a body 110, an engaging member 120, and a battery 130.

The body 110 is a basic structure of the mobile phone 100, and basic devices required by the mobile phone 100 are provided therein. Since the basic devices are the same as those of the conventional mobile phone, their description is omitted. Referring to FIG. 3a, the body 110 is formed with a receiving portion 111 for receiving the battery 130. A slot 112 is formed at the bottom portion of the body 110, and is located at the periphery of the receiving portion 111.

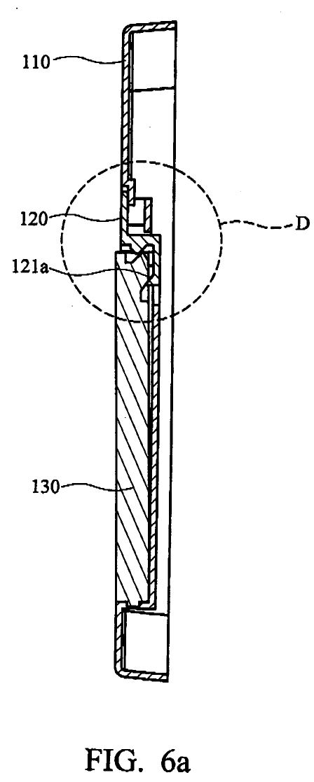

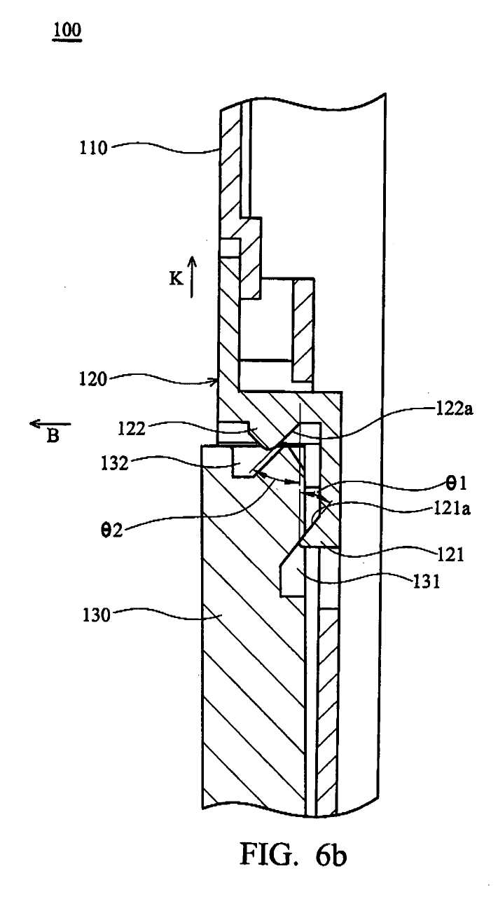

The engaging member 120 is a device for fixing the battery 130, and is moveably disposed on the body 110. As shown in FIG. 3b, the engaging member 130 includes a first rib 121 and a second rib 122 thereon. As shown in FIG. 6b, the first rib 121 includes a first inclined surface 121a, and the second rib 122 includes a second inclined surface 122a.

Referring to FIG. 3a and FIG. 3b, a main part 126 of the engaging member 120 is divided into a first surface 123, a second surface 124, and a third surface 125. A normal vector of the first surface 123 is perpendicular to a moving direction K, as shown in FIG. 6b, of the engaging member 120. A normal vector of the second surface 124 is parallel with the moving direction K of the engaging member 120. A normal vector of the third surface 125 is perpendicular to the moving direction K of the engaging member 120. Additionally, the second surface 124 connects the first surface 123 and the third surface 125. When the battery 130 is disposed in the receiving portion 111 of the body 110, the first surface 123 and the second surface 124 are covered by the battery 130, and the third surface 125 is exposed by the body 110.

Referring to FIG. 6b, the first rib 121 is formed on the first surface 123, and the second rib 122 is formed on the second surface 124. A first angle θ1 is formed between the first inclined surface 121a of the first rib 121 and the normal vector of the second surface 124. A second angle θ2 is formed between the second inclined surface 122a of the second rib 122 and the normal vector of the second surface 124. The first angle θ1 is preferably smaller than the second angle θ2. Thus, the battery 130 can be easily removed from the body 110.

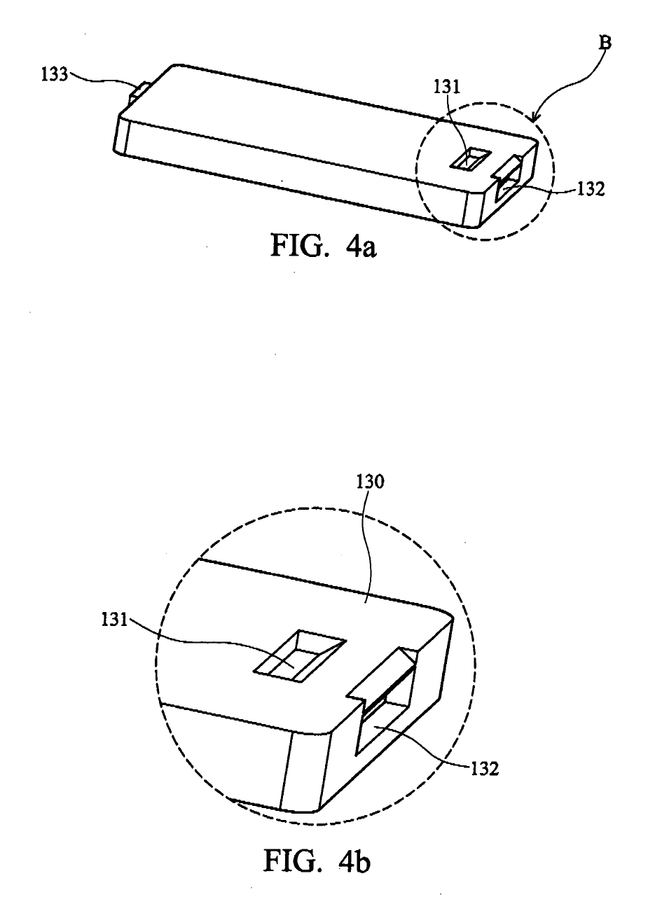

The battery 130 is detachably disposed on the body 110. As shown in FIG. 4a and FIG. 4b, the battery 130 includes a first concave portion 131 at its bottom surface facing the body 110, and a second concave portion 132 at an end surface connecting to the bottom surface. The first concave portion 131 corresponds to the first rib 121 of the engaging member 120, and the second concave portion 132 corresponds to the second rib 122 of the engaging member 120. When the battery 130 is disposed in the receiving portion 111 of the body 110, the first rib 121 is located in the first concave portion 131, and the second rib 122 is located in the second concave portion 132.

Referring to FIG. 4a, the battery 130 includes a protrusion 133 at an end surface opposite to the second concave portion 132. The protrusion 133 corresponds to the slot 112 of the body 110. When the battery 130 is disposed in the receiving portion 111 of the body 110, the protrusion 133 is located in the slot 112.

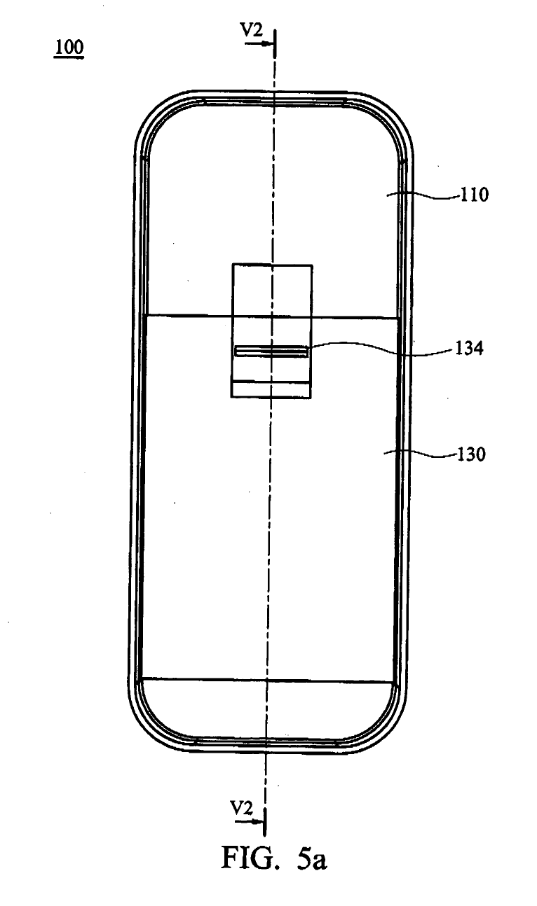

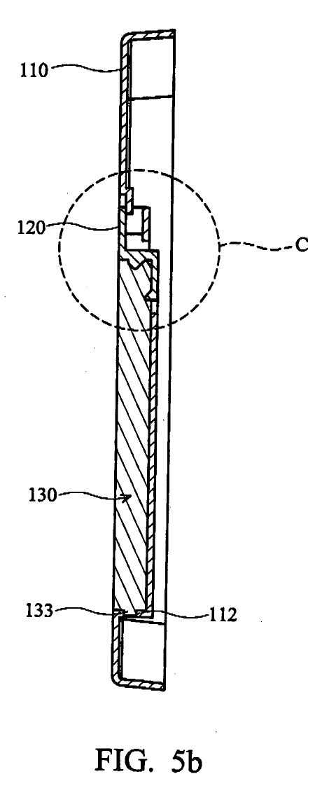

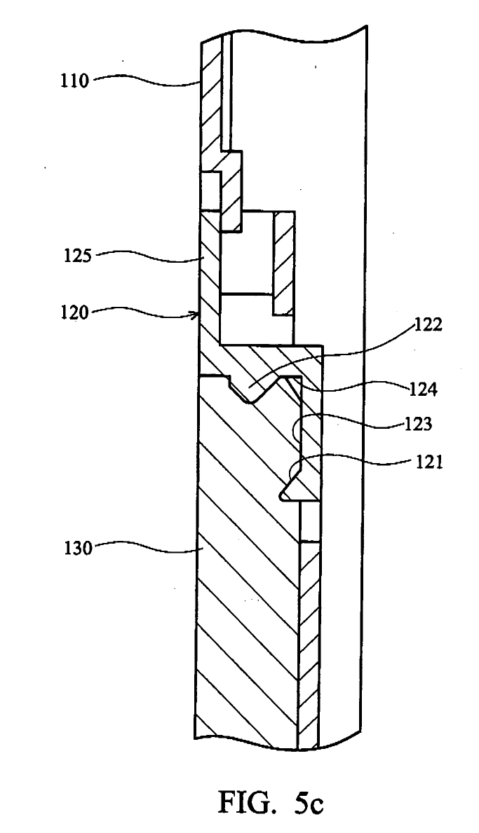

Referring to FIG. 5a, the battery 130 includes a knob 134 thereon. The battery 130 can be disengaged from the body 110 by moving the knob 134.

Referring to FIGS. 5a-5c, when the battery 130 is disposed in the body 110, the first rib 121 of the engaging member 120 is located in the first concave portion 131 of the battery 130 while the second rib 122 of the engaging member 120 is located in the second concave portion 132 of the battery 130. At this time, the protrusion 133 of the battery 130 is located in the slot 112 of the body 110. The battery 130 can be positioned in the body 110 by engaging the second rib 132 and the protrusion 133 with the second concave portion 122 and the slot 112 respectively. The battery 130 and the engaging member 120 also contact each other via the inclined surfaces 121a, 122a.

To disengage the battery 130 from the body 110, the knob 134 of the battery 130 is pushed so that the engaging member 120 is moved in a direction as shown by arrow K in FIG. 6b. The second rib 122 is then separated from the second concave portion 132 as shown in FIG. 6a and FIG. 6b. At this time, the battery 130 is correspondingly lifted by the first inclined surface 121a of the first rib 121 in a direction as shown by arrow B in FIG. 6b. As a result, the battery 130 can be easily separated and removed from the body 110.

It is noted that the knob 134 of the battery 130 is not illustrated in FIG. 5b, FIG. 5c, FIG. 6a, and FIG. 6b.

By the structure of the invention, since the rib is additionally in the device to engage the battery, the battery can be easily lifted during the movement of the engaging member, thus, the battery can be easily removed.

Additionally, since the relationship between the angles of the inclined surfaces of the ribs is designed based on a geometric theorem, the battery can be easily removed.

While the invention has been described by way of example and in terms of the preferred embodiment, it is to be understood that the invention is not limited to the disclosed embodiment. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A mobile phone comprising:
a body;
an engaging member, moveably disposed on the body, including a first rib having a first inclined surface; and
a battery, detachably disposed on the body, including a first concave portion corresponding to the first rib, wherein the first rib is located in the first concave portion, and the battery is lifted by the first inclined surface so as to be separated from the body.

2. The mobile phone as claimed in claim 1, wherein the engaging member further includes a second rib, the battery further includes a second concave portion corresponding to the second rib, and the second rib is located in the second concave portion.

3. The mobile phone as claimed in claim 2, wherein the engaging member further includes a first surface and a second surface, a normal vector of the first surface is perpendicular to a moving direction of the engaging member, the first rib is formed on the first surface, a normal vector of the second surface is parallel with the moving direction of the engaging member, and the second rib is formed on the second surface.

4. The mobile phone as claimed in claim 3, wherein the second rib includes a second inclined surface, a first angle is formed between the first inclined surface and the normal vector of the second surface, a second angle is formed between the second inclined surface and the normal vector of the second surface, and the first angle is smaller than the second angle.

5. The mobile phone as claimed in claim 3, wherein the engaging member further includes a third surface, and a normal vector of the third surface is perpendicular to the moving direction of the engaging member.

6. The mobile phone as claimed in claim 5, wherein the second surface connects the first surface and the third surface.

7. The mobile phone as claimed in claim 5, wherein the first surface and the second surface are covered by the battery, and the third surface is exposed by the body.

8. The mobile phone as claimed in claim 1, wherein the body includes a slot,. and the battery includes a protrusion corresponding to the slot.

9. The mobile phone as claimed in claim 8, wherein the protrusion and the second concave portion are formed on opposite sides of the battery.

10. A device for fixing a battery of a mobile phone, wherein the mobile phone includes a body and a battery, the battery includes a concave portion, and the device includes:
a main part moveably disposed on the body; and
a first rib, integrally formed on the main part, including a first inclined surface, wherein the first rib is located in the concave portion, and the battery is lifted by the first inclined surface so as to be separated from the body.

11. The device as claimed in claim 10, further comprising:
a second rib integrally formed on the main part.

12. The device as claimed in claim 11, wherein the main part further includes a first surface and a second surface, a normal vector of the first surface is perpendicular to a moving direction of the main part, the first rib is formed on the first surface, a normal vector of the second surface is parallel with the moving direction of the main part, and the second rib is formed on the second surface.

13. The device as claimed in claim 12, wherein the second rib includes a second inclined surface, a first angle is formed between the first inclined surface and the normal vector of the second surface, a second angle is formed between the second inclined surface and the normal vector of the second surface, and the first angle is smaller than the second angle.

14. The device as claimed in claim 12, wherein the main part further includes a third surface, and a normal vector of the third surface is perpendicular to the moving direction of the main part.

15. The device as claimed in claim 14, wherein the second surface connects the first surface and the third surface.

16. The device as claimed in claim 14, wherein the first surface and the second surface are covered by the battery, and the third surface is exposed by the body.
